(19) United States
(12) Patent Application Publication
(10) Pub. No.: US 2012/0005505 A1
(43) Pub. Date: Jan. 5, 2012

(54) Determining Status Assignments That Optimize Entity Utilization And Resource Power Consumption

(76) Inventors: Niraj Tolia, Mountain View, CA (US); Zhikui Wang, Fremont, CA (US); Manish Marwah, Mountain View, CA (US); Cullen E. Bash, Los Gatos, CA (US); Parthasarathy Ranganathan, Fremont, CA (US); Xiaoyun Zhu, Cupertino, CA (US)

(21) Appl. No.: 13/256,380

(22) PCT Filed: Mar. 13, 2009
(86) PCT No.: PCT/US09/37177

§ 371 Date: Sep. 13, 2011

(51) Int. Cl. G06F 1/32

(52) U.S. Cl. 713/320

(57) ABSTRACT

In a method of determining status assignments for a plurality of entities that substantially optimizes a total power consumption of the plurality of entities and a plurality of resource actuators, at least one entity power model for the entities and at least one resource power model for the resource actuators are developed. In addition, a constraint optimization problem having an objective function and at least one constraint is formulated and the problem is solved by employing a search tool, the at least one entity power model, and the at least one resource power module on the objective function to identify status assignments for the entities that results in the optimized total power consumption.

### CROSS-REFERENCE TO RELATED DISCLOSURE

The present application shares some common subject matter with U.S. patent application Ser. No. TBD (Attorney Docket No. 200802683-1), filed on TBD, the disclosure of which is hereby incorporated by reference in its entirety.

### BACKGROUND

Power is a critical issue in the design and operation of enterprise servers and data centers and is expected to continue to increase in importance due to the ever increasing demands of servers and data centers. Power consumed by cooling equipment (for instance, fans and computer room air conditioners) has also become a significant component in the design and operation of the enterprise servers and data centers. By way of example, the yearly electricity costs for the cooling equipment alone in a large data center (for instance, 30,000 square feet, rated at 10 MW) has been known to run in the millions of dollars.

The same trends in increased power consumption levels are also becoming more applicable at smaller scales, for instance, at the cluster level, or even at an individual server level. More particularly, with increasingly dense compute infrastructures and more powerful processors, the server fans are known to consume increasingly large amounts of power. For instance, the peak power usage by fans and certain blade servers has been found to be as high as 2000 W, which comprises about 23% of the typical system power of the blade server.

### BRIEF DESCRIPTION OF THE DRAWINGS

Features of the present invention will become apparent to those skilled in the art from the following description with reference to the figures, in which:

FIG. 1A shows a simplified block diagram of a system for determining status assignments for a plurality of entities that substantially optimizes a total power consumption of the entities and a plurality of resource actuators configured to variably supply resources to the entities, according to an embodiment of the invention;

FIG. 1B shows a more detailed schematic block diagram of the system depicted in FIG. 1A, according to an embodiment of the invention;

FIG. 2 illustrates a flow diagram of a method of determining status assignments for a plurality of entities that substantially optimizes a total power consumption of the plurality of entities and a plurality of resource actuators, according to an embodiment of the invention;

FIGS. 3A and 3B, collectively show a flow diagram of a method of employing the search tool to solve a constraint optimization problem and to thus identify status workloads for the plurality of entities that results in the substantially optimized total power consumption, according to an embodiment of the invention; and

FIG. 4 shows a block diagram of a computing apparatus configured to implement or execute the optimizer depicted in FIGS. 1A and 1B, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are a system and method for determining status assignments for a plurality of entities that substantially optimizes a total power consumption of the plurality of entities and a plurality of resource actuators configured to variably supply resources to the entities. The status assignments may include, for instance, workload assignments, on/off settings, sleep/awake modes, etc. In addition, as discussed in greater detail herein below, candidate status assignments are determined through use of a search tool, such as, simulated annealing, hill climbing, etc., to determine a solution to an objective function of a constraint optimization problem. Moreover, at least one entity power model and at least one resource power model are used to determine impacts of the candidate status assignments on the objective function.

The power consumption settings for the entities that results in optimized total power (both entity power and resource power) consumption is determined from the candidate status assignments based upon real time information on the entities and the resource actuators. The total power consumption is considered to be optimized when the entities are able to perform the workloads assigned to the entities without substantially violating any performance or environmental condition constraints, and while satisfying a predetermined power consumption threshold or while the total power consumption is minimized for at least a set of candidate status assignments.

Through implementation of the system and method disclosed herein, the amount of power consumed by the entities in performing the workloads and the resource actuators in providing resources, such as, cooling resources, to the entities may be optimized to meet a predetermined power consumption threshold or a minimum total power consumption level. This optimized total power consumption translates into savings in both operating cost and, in certain instances, CO₂ emissions. In addition, because the determination of the workload assignments is made through a model-based approach based on physics, the models may evolve with the system, thereby resulting in a robust control system.

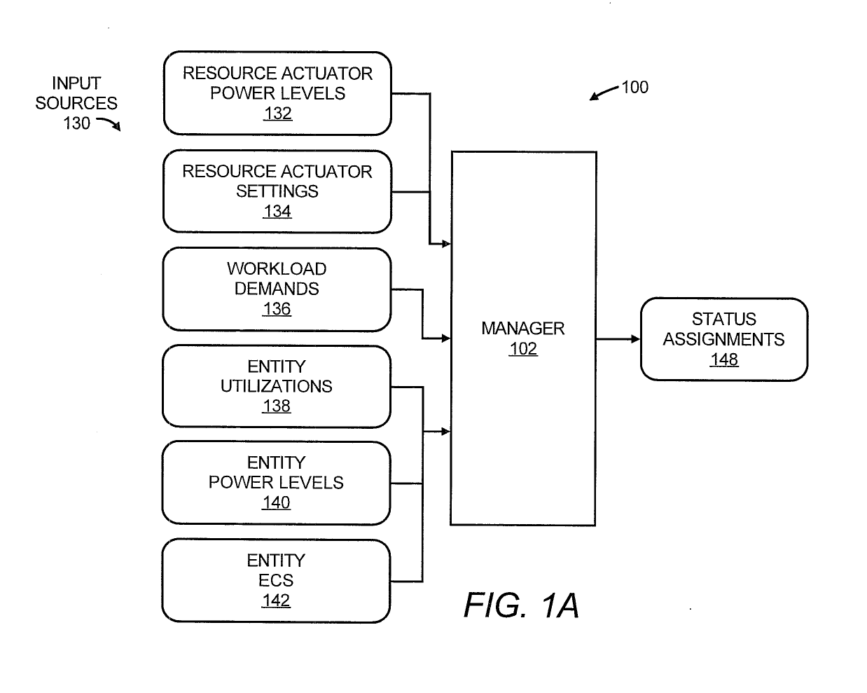

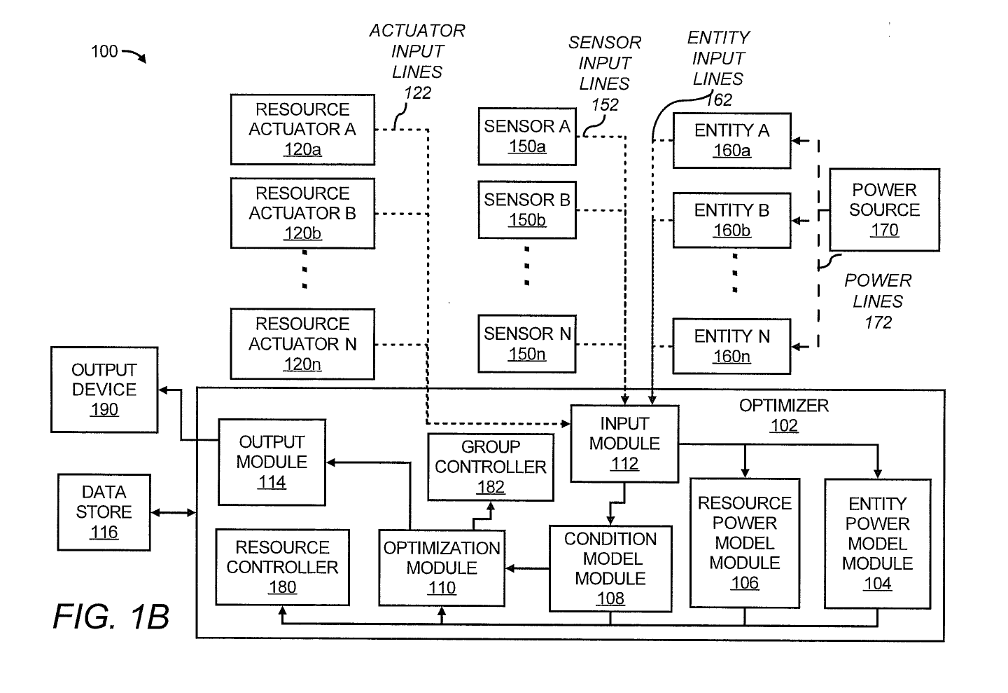

With reference first to FIG. 1A, there is shown a simplified schematic diagram of a system 100 for determining status assignments for a plurality of entities that substantially optimizes a total power consumption of the entities and a plurality of resource actuators configured to variably supply resources to the entities, according to an example. It should be understood that the system 100 (depicted in FIGS. 1A and 1B) may include additional elements and that some of the elements described herein may be removed and/or modified without departing from the scope of the system 100 (depicted in FIGS. 1A and 1B).

As shown, the system 100 includes an optimizer 102, which may comprise software, firmware, and/or hardware and is configured to determine status assignments for a plurality of entities 160a-160n (FIG. 1B) that substantially optimizes a total power consumption of the entities 160a-160n and a plurality of resources 120a-120n (FIG. 1B). The status assignments may include, for instance, workload assignments, on/off settings, sleep/awake modes, etc. The resource actuators 120a-120n are configured to affect one or more conditions at one or more entities 160a-160n. Thus, the resource actuators 120a-120n may be considered as providing shared resources, such as, cooling or other environmental condition resources, to the entities 160a-160n, which may comprise any heat generating device, such as, electronic chips, servers, power supplies, networking equipment, storage devices, etc.

Although the resource actuators 120a-120n and the entities 160a-160n may comprise any number of different combinations of elements, the following examples are provided to afford a clearer understanding of potential relationships between resource actuators 120a-120n and entities 160a-160n. As a first particular example, the resource actuators 120a-120n comprise fans and the entities 160a-160n comprise servers, in which the fans and servers are positioned in an enclosure. As another particular example, the resource actuators 120a-120n comprise air conditioning units and the entities 160a-160n comprise servers housed in racks, in which the air conditioning units and the servers are housed in a room, such as a data center. As a further particular example, the resource actuators 120a-120n comprise firing actuators positioned in nozzles of a fluid jetting device and one of the entities 160a comprises an electronic chip having multiple cores. As a yet further particular example, the resource actuators 120a-120n comprise pumps and the entities 160a-160n comprise air conditioning units, in which the pumps are positioned along various pipes configured to supply a cooling fluid to the air conditioning units.

According to an example, the total power consumption of the entities 160a-160n and the resources 120a-120n is considered to be substantially optimized when the entities 160a-160n and the resource actuators 120a-120n are able to be operated to perform the workload demands without substantially violating any performance or environmental condition constraints, and while satisfying a predetermined power consumption threshold or while the total power consumption is minimized for at least a set of candidate workload assignments. In certain instances, one or more of the performance or environmental condition constraints may be waived. Thus, for instance, the optimizer 102 is configured to determine status assignments for the entities 160a-160n that results in both the power consumed by the entities 160a-160n in meeting the workload demands and the power consumed by the resource actuators 120a-120n in meeting the environmental condition demands of the entities 160a-160n to be minimized or to meet the predetermined power consumption threshold.

As shown in FIG. 1A, the optimizer 102 is depicted as receiving data from various input sources 130, which are described in greater detail herein below with respect to FIG. 1B. The data includes resource actuator 120a-120n power levels 132, resource actuator 120a-120n settings 134, workload demands 136, entity 160a-160n utilization levels 138, entity 160a-160n power levels 140, entity 160a-160n environmental conditions 142. The optimizer 102 is generally configured to determine the status assignments among the entities 160a-160n that results in an optimized total power consumption based upon the data received from the input sources 130.

Turning now to FIG. 1B, there is shown a more detailed schematic block diagram of the system 100 depicted in FIG. 1A, according to an example. As shown therein, the optimizer 102 includes an entity power model module 104, a resource power model module 106, a condition model module 108, an optimization module 110, an input module 112, and an output module 114. The modules 104-114 are designed to perform various functions in the optimizer 102 using data obtained from the input sources 130 as described below. The optimizer 102 is also depicted as optionally including a resource controller 180 and a group controller 182.

In instances where the optimizer 102 comprises software, the optimizer 102 may be stored on a computer readable storage medium and may be executed or implemented by a computing device processor (not shown). In these instances, the modules 104-114 may comprise software modules or other programs or algorithms configured to perform the functions described herein below. In instances where the optimizer 102 comprises firmware and/or hardware, the optimizer 102 may comprise a circuit or other apparatus configured to perform the functions described herein below. In these instances, the modules 104-114 may comprise one or more of software modules and hardware modules configured to perform these functions.

In addition to the optimizer 102, the resource actuators 120a-120n, and the entities 160a-160n, the system 100 is depicted as including a plurality of sensors 150a-150n. The “n” denotes an integer value greater than or equal to one in each of the previously discussed reference numerals, and thus indicates that the system 100 may include one or more resource actuators 120a-120n, one or more sensors 140a-140n, and one or more entities 150a-150b.

Each of the resource actuators 120a-120n may generally be defined as any reasonably suitable device capable of varying the provisioning of a shared resource, such as, a cooling fluid, air, water, etc., to one or more of the entities 160a-160n. In addition, each of the resource actuators 120a-120n may have multiple settings, for instance, settings in addition to “on” and “off” to thus vary the supply of the shared resource to multiple levels. Moreover, the resource actuators 120a-120n may comprise homogeneous or heterogeneous devices. As an example of heterogeneous devices, for instance, one of the resource actuators 120a may be configured to vary the supply of airflow whereas another one of the resource actuators 120b may be configured to vary the supply of a liquid coolant provided to one or more of the entities 160a-160n.

Likewise, each of the entities 160a-160n may be defined as any device configured to perform a workload, such as, run an application, perform network switching functions, perform data storage operations, perform cooling functions (air conditioning units), etc., that is positioned to be affected by variations of the supply of the resources by one or more of the resource actuators 120a-120n. In addition, the sensors 150a-150n are configured to sense one or more of the conditions, such as, temperature, fluid flow volume, fluid flow velocity, pressure, humidity, thermal resistance, etc., around or in the entities 160a-160n. The sensors 150a-150n may have a one-to-one correlation with the entities 160a-160n or there may be more or fewer sensors 150a-150n as compared with entities 160a-160n.

According to an example, each of the sensors 150a-150n may be associated with one or more of the entities 160a-160n and may thus be configured to detect one or more conditions of a resource supplied to respectively associated entities 160a-160n. Thus, for instance, a first sensor 150a is configured to detect a condition of a resource supplied to a first entity 160a, a second sensor 150b is configured to detect a condition of a resource supplied to a second entity 160b, etc. According to an example, the first sensor 150a may be positioned at a fluid inlet of a first entity 160a, the second sensor 150b may be positioned at a fluid inlet of a second entity 160b, etc. In another example, the first sensor 150a may be positioned within a first entity 160a, the second sensor 150b may be positioned within a second entity 160b, etc. In the second example, the sensors 150a-150n may be positioned within respective entities 160a-160n to, for instance, detect the temperatures of CPUs contained in the respective entities 160a-160n.

As further shown in FIG. 1B, the entities 160a-160n receive power from a power source 170 through respective power lines 172. Although not shown, the optimizer 102, the resource actuators 120a-120n, and the sensors 150a-150n also receive power from a power source, which may be the same or differ from the power source 170. In any regard, the amount of power that the entities 160a-160n draw from the power source 170 may be tracked through any suitable known manner. For instance, each of the entities 160a-160n may be equipped with a power meter configured to measure the amount of power that each of the entities 160a-160n consumes. As another example, power meters may be positioned along the power lines 172, externally to the entities 160a-160n, to measure the power supplied into the entities 160a-160n. As a further example, the amount of power consumed by the entities 160a-160n may be calculated, for instance, based upon the levels at which the entities 160a-160n are operating. By way of particular example in which the entities 160a-160n comprise servers, the operating levels of the processors may be used to calculate the power consumption levels of the servers.

The input module 112 is configured to receive input from input sources 130, which, in one example, include, the resource actuators 120a-120n, sensors 150a-150n, and entities 160a-160n. The input module 112, more particularly, is configured to receive settings 134 of the resource actuators 120a-120n via actuator input lines 122, conditions sensed 142 by the sensors 150a-150n via sensor input lines 152, and the entity utilizations 138 and power levels 148 via entity input lines 162. The input module 112 may also be configured to receive resource actuator 120a-120n power consumption levels via the actuator input lines 122. In addition, the optimizer 102 is configured to receive workload demand 136 information for workloads to be placed or currently being placed on the entities 160a-160n either through the input module 112 or through another input apparatus.

In other examples, the input module 112 is configured to receive input from devices configured to track one or more operating conditions of the resource actuators 120a-120n and/or the entities 160a-160n. These devices may include, for instance, devices positioned internally or externally to the resource actuators 120a-120n configured to track the settings of the resource actuators 120a-120n. By way of example, the devices may comprise encoders that detect the positions of various components, such as, louvers, pump components, fan components, etc., configured to vary the flow of fluid through the resource actuators 120a-120n. As another example, these devices may comprise sensors positioned to detect a characteristic, such as, velocity, pressure, volume flow rate, etc., of fluid flow supplied through the resource actuators 120a-120n, which may be used to determine the resource actuator 120a-120n settings.

These devices may also include, for instance, devices positioned internally or externally to the entities 160a-160n, such as power meters, configured to measure the power consumption levels of the entities 160a-160n.

The optimizer 102 may store data received through the input module 112 in a data store 116, which the optimizer 102 may access in performing various functions discussed below. The data store 116 may comprise volatile and/or non-volatile memory, such as DRAM, EEPROM, MRAM, flash memory, and the like. In addition, or alternatively, the data store 116 may comprise a device configured to read from and write to a removable media, such as, a floppy disk, a CD-ROM, a DVD-ROM, or other optical or magnetic media.

The entity power model module 104 is configured to develop at least one entity power model, in which, the at least one entity power model characterizes the relationship between utilization levels and power consumption levels of an entity 160a-160n. In instances where the entities 160a-160n comprise homogeneous entities, the entity power model module 104 may develop a single entity power model. In instances where the entities 160a-160n comprise heterogeneous entities, the entity power model module 104 may develop a separate entity power model for each type of entity. In any regard, the entity power model module 104 is configured to develop the entity power model(s) through use of any reasonably suitable standard model construction techniques, such as, physics-based models, empirical models based upon experimental data, machine learning models, etc., for instance, through use of data received through the input module 112.

By way of particular example in which the entities 160a-160n comprise blade servers, the entity power model module 104 may develop the entity power model as:

P_{B}_{ⱼ}=g_{B}*Utilⱼ+P_{B,idle}. Equation (1):

Equation (1) generally relates the power consumption (P) for a jth blade (B) based upon the utilization (Utilⱼ) of the jth blade and the idle power (P_{B,idle}) of the blade, which is the power consumption of the blade (B) at an idle state. The coefficient g_{B} may be determined by collecting experimental data pertaining to the utilization levels of the entities 160a-160n and the power consumption levels of the entities 160a-160n at both idle and active states, and by fitting the function g_{B} to the data. More particularly, the entity power model module 104 may develop the power model for the entities 160a-160n by measuring their power consumption levels under differing loading conditions and fitting the function g_{B} to that data. According to one result based upon experimental data, the power consumption (P) was found to be a linear function of the utilization of the processors or CPUs of the entities 160a-160n and g_{B} is the slope of the line formed by a plot of the data.

It should be noted that when the entities 160a-160n comprise other types of entities, such as, network switches, storage arrays, etc., the entity power model module 104 may develop one or more different entity power models. Thus, for instance, the function g_{B} in Equation (1) will likely vary depending upon the specific type of entity for which the entity power model is developed.

The resource power model module 106 is configured to develop at least one resource power model that relates the settings of the resource actuators 120a-120n to power consumption levels of the resource actuators 120a-120n. In instances where the resource actuators 120a-120n comprise homogeneous resource actuators, the resource power model module 106 may develop a single resource power model. In instances where the resource actuators 120a-120n comprise heterogeneous resource actuators, the resource power model module 106 may develop a separate resource power model for each type of resource actuator. In any regard, the resource power model module 104 is configured to develop the resource power model(s) through use of any reasonably suitable standard model construction techniques, such as, physics-based models, empirical models based upon experimental data, machine learning models, etc.

According to a particular example, the resource model module 106 is configured to develop the resource power model through application of a suitable algebraic form of the relationship between the power consumed by a resource actuator 120a-120n and its setting. An example of a suitable form is:

Pᵢ=fᵢ(Aᵢ). Equation (2):

In Equation (2), Pᵢ is the power consumed by the ith resource actuator 120a-120n, Aᵢ is the setting of the ith resource actuator 120a-120n, and fᵢ is an algebraic function relation Pᵢ to Aᵢ. In addition, the total power consumption (P) of the plurality of resource actuators 120a-120n is defined as the sum of the power consumption levels of the resource actuators 120a-120n, or:

P=ΣPᵢ. Equation (3):

According to an example, the settings of the resource actuators 120a-120n may be expressed as vectors. In addition, the function fᵢ may be determined by collecting experimental data pertaining to the resource actuator 120a-120n settings and their power consumption levels and by fitting the function fᵢ to the experimental data. It should be noted that the function fᵢ in Equation (2) will likely vary depending upon the specific type of resource actuator for which the resource power model is developed.

The condition model module 108 is configured to develop a condition model that relates the settings of the plurality of resource actuators 120a-120n to an environmental condition at the location of at least one entity 160a-160n and a power consumption level of the at least one entity 160a-160n. In instances where the entities 160a-160n comprise homogeneous entities and the resource actuators 120a-120n comprise homogeneous resource actuators, the condition model module 108 may develop a single condition power model. In instances where the entities 160a-160n comprise heterogeneous entities and/or the resource actuators 120a-120n comprise heterogeneous resource actuators, the condition model module 108 may develop a separate condition model for each type of entity and/or resource actuator. In any regard, the condition model module 108 is configured to develop the condition power model(s) through use of any reasonably suitable standard model construction techniques, such as, physics-based models, empirical models based upon experimental data, machine learning models, etc.

According to a particular example, the condition model module 108 is configured to develop the condition model through application of a suitable algebraic form of the relationship between the resource actuator 120a-120n settings, the detected environmental condition, and the power consumed by the at least one entity 160a-160n, material properties of the at least one entity 160a-160n, such as, thermal resistance, etc. Although the form of the relationship may take many forms depending upon any number of various factors, an example of a suitable form is:

ECᵢ=gᵢ(A₁, . . . , Aₙ, PEᵢ). Equation (4):

In Equation (4), ECᵢ is the condition at the ith entity 160a-160n, Aⱼ is the setting of the jth resource actuator 120a-120n, PEᵢ is the power consumed by the ith entity 160a-160n, and gᵢ is an algebraic function relating the condition to the resource actuator settings and the power consumption level of the ith entity 160a-160n. In addition, the function gᵢ may be determined by collecting experimental data pertaining to the resource actuator 120a-120n settings, the power consumption levels of the entities 160a-160n, and the detected conditions and by fitting the function gᵢ to the data. It should be noted that when the entities 160a-160n comprise heterogeneous entities, such as, blade servers, network switches, storage arrays, etc., the function gᵢ will depend upon the specific type of entity.

The optimization module 110 is configured to formulate a constraint optimization problem having an objective function and at least one constraint. According to an example, the objective function is configured to minimize entity 160a-160n and resource actuator 120a-120n total power consumption. An example of a suitable objective function for minimizing power consumption in an enclosure containing i fans and j blades, is denoted in the following equation:

$$min ( {Σ }_{i} {P}_{{F}_{i}} + {Σ}_{j} {P}_{{B}_{j}} ) . \qquad Equation ( 5 )$$

In Equation (5), P_{F}_{ᵢ} is the power consumed by fan i and P_{B}_{ⱼ} is the power consumed by the blade j.

In addition, the at least one constraint comprises at least one of setpoint environmental conditions at locations of the plurality of entities 160a-160n and maximum entity 160a-160n resource utilization levels. The setpoint environmental conditions may comprise particular setpoints or a range of environmental condition values that the plurality of entities 160a-160n are intended to remain within. In another example, the setpoint environmental conditions may comprise reference conditions that the entities 160a-160n are to remain below or remain above. By way of particular example, if the environmental condition comprises temperature, the constraint on the temperature value (Tⱼ) of each entity 160a-160n to remain equal to or below a reference temperature (T_{ref}) may be defined by the following equation:

Tⱼ≦T_{ref} Equation (6):

Likewise, the utilization levels of the entities 160a-160n (Utilⱼ) should remain below a reference threshold (Util_{ref}) to substantially prevent negative impacts on the performance of the entities 160a-160n. The following is an equation that defines this requirement:

Utilⱼ≦Util_{ref}. Equation (7):

By way of example, the at least one constraint captures a condition setpoint requirement, such as, temperature, pressure, humidity, etc., at each entity 160a-160n, requiring a setpoint environmental condition. The setpoint environmental condition may be specified in terms of threshold conditions at one or more locations within or outside of an entity 160a-160n. In addition, the optimization module 110 may employ the condition model(s) to quantify the setpoint condition requirement.

The optimization module 110 is configured to solve the optimization problem formed of the objective function and the at least one constraint discussed above through use of a search tool configured to search through a relatively large space for a solution to the optimization problem, where the solution results in the identification of status assignments on the plurality of entities 160a-160n that yields an optimized total power (both entity power and resource power) consumption. More particularly, for instance, given n entities 160a-160n and the current assignment of m workloads to the n entities 160a-160n, the optimization module 110 is configured to employ the search tool to search through a relatively large space of candidate status assignments to determine a new assignment of the m workloads, such that the total power (entity power and resource power) is substantially optimized, for instance, that the total power consumption is substantially minimized or is maintained within a predetermined power consumption threshold level. Examples of suitable search tools include simulated annealing, hill climbing, local beam search, genetic algorithms, etc.

The selection of which of the search tools to employ may be based upon the nature of the objective function, for instance, whether it is linear, quadratic, cubic, etc. and the nature of the at least one constraint, for instance, whether it is linear or non-linear.

In any regard, the optimization module 110 is configured to employ the entity power model(s) and the resource power model(s) while solving the constraint optimization problem to determine impacts of the identified candidate status assignments on the objective function. Thus, for instance, the optimization module 110 may identify a plurality of candidate status assignments and may determine the entity 160a-160n power consumption levels through application of the entity power model(s) and the resource actuator 120a-120n power consumption levels through application of the resource power model(s) for each of the plurality of candidate status assignments. In addition, the optimization module 110 may identify the status assignments for the entities 160a-160n from the candidate status assignments that results in a substantially optimized total power consumption.

According to an example, the optimization module 110 stores the solution to the constraint optimization problem or the identified status assignments in the data store 116. According to another example, the optimization module 110 employs the output module 114 to output the solution or the identified status assignments to an output device 190, such as, a computing device, a display screen, a printer, a network device, etc.

According to a further example in which the optimizer 102 is configured to control the workload distribution/re-distribution among the entities 160a-160n, including the status, such as, on/off, awake/sleep, etc., of the entities 160a-160n and the operations of the resource actuators 120a-120n, the optimizer 102 also includes a resource controller 180 and a group controller 182. The resource controller 180 is configured to control the settings of the resource actuators 120a-120n to substantially ensure that the environmental conditions at the entities 160a-160n remain below one or more predefined thresholds, which may comprise overload thresholds. An example of a suitable resource controller 180 is disclosed in the TBD (Attorney Docket No. 200802683-1 application for patent. In this regard, the resource controller 180 is configured to receive various power models and condition models to determine optimized settings of the resource actuators 120a-120n as described in that application for patent, and may operate independently of the group controller 182.

The group controller 182 may be configured to dynamically assign virtual machines (VMs) hosting workloads to the specific entities 160a-160, which are blade servers in this example, based upon the status assignments identified by the optimization module 110. The status assignments may include, an original distribution of workloads among the entities 160a-160n or a re-distribution of the workloads among the entities 160a-160n. In addition, the group controller may set one or more of the entities 160a-160n to be set to an idle or an off state when the optimization module 110 determines that the total power consumption is reduced or minimized with the one or more of the entities 160a-160n set to the idle state.

The workloads described with respect to this example are units of computation, such as a process, or a group of closely related processes. As such, when the group controller 182 seeks to re-distribute a workload from a source entity 160a to a target entity 160b, the group controller 182 suspends performance of the workload on the source entity 160a and resumes a workload on the target entity 160b. In addition, the group controller 182 may cause state information from the source entity 160a to be copied to the target entity 160b. Thus, in one regard, the group controller 182 may perform migration of the workloads between similar types of entities 160a-160n

Although not shown, each of the entities 160a-160n, for instance, in the case of blade servers, may include a local efficiency controller (EC) that adjusts the power state of the individual blade server to match its resource utilization.

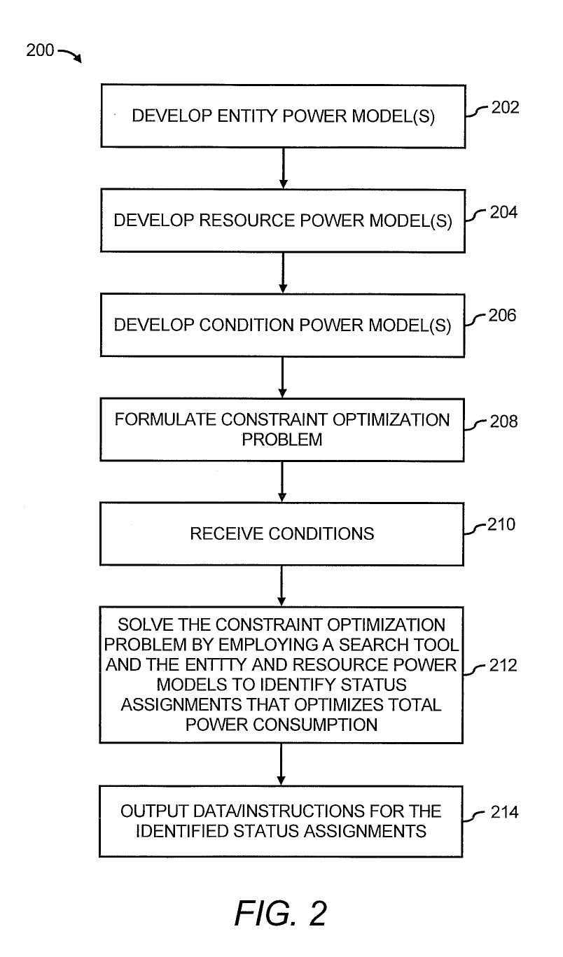

An example of a method in which the optimizer 102 may be operated will now be described with respect to the following flow diagram of the method 200 depicted in FIG. 2. More particularly, FIG. 2 depicts a flow diagram of a method 200 of determining status assignments for a plurality of entities 160a-160n that substantially optimizes a total power consumption of the plurality of entities 160a-160n and a plurality of resource actuators 120a-120n configured to supply resources to the plurality of entities 160a-160n, according to an example. It should be apparent to those of ordinary skill in the art that the method 200 represents a generalized illustration and that other steps may be added or existing steps may be removed, modified or rearranged without departing from a scope of the method 200.

The description of the method 200 is made with reference to the systems 100 illustrated in FIGS. 1A and 1B, and thus makes reference to the elements cited therein. It should, however, be understood that the method 200 is not limited to the elements set forth in the systems 100. Instead, it should be understood that the method 200 may be practiced by a system having a different configuration than that set forth in the systems 100.

A controller, such as a processor (not shown), may implement or execute the optimizer 102 to perform one or more of the steps described in the method 200. In addition, the controller may implement or execute the optimizer 102 to perform the method 200 at predetermined intervals of time, as new workloads are received, as manually instructed, etc. In one regard, the method 200 may be performed on a substantially continuous basis to substantially continuous optimize the total power consumed by the entities 160a-160n and the resource actuators 120a-120n.

At step 202, the entity power model module 104 develops at least one entity power model for the plurality of entities 160a-160n. As discussed above, the number of entity power models developed may depend upon the number of different types of entities contained in the plurality of entities 160a-160n. In addition, the entity power model(s) characterizes the relationship between a utilization level and a power consumption level of the entities 160a-160n.

At step 204, the resource power model module 106 develops at least one resource power model for the resource actuators 120a-120n. As discussed above, the number of resource power models developed may depend upon the number of different types of resource actuators contained in the plurality of resource actuators 120a-120n. In addition, the resource power model(s) relates the settings of the plurality of resource actuators 120a-120n to power consumption levels of the plurality of resource actuators 120a-120n.

At step 206, the condition model module 108 develops at least one condition model that relates the settings of the plurality of resource actuators 120a-120n to an environmental condition at the location of at least one entity 160a-160n and a power consumption level of the at least one entity 160a-160n. As discussed above, the number of condition models developed may depend upon the number of different types of entities 160a-160n and/or resource actuators 120a-120n contained in the system 100.

At step 208, the optimization module 110 formulates a constraint optimization problem having an objective function. As discussed above, the objective function may be configured to minimize entity 160a-160n and resource infrastructure 120 power consumption. In addition, the at least one constraint comprises at least one of setpoint environmental conditions, such as, temperature, at locations of the plurality of entities 160a-160n and maximum entity 160a-160n resource utilization levels.

At step 210, the optimizer 102 receives substantially real time conditions. The conditions may include, for instance, the conditions detected by the sensors 150a-150n, the power levels of the entities 160a-160n, etc. In addition, the conditions are considered to be received in substantially real time to thus capture relatively current conditions.

At step 212, the optimization module 110 solves the constraint optimization problem based upon the substantially real time conditions received at step 210, in which the solution to the constraint optimization problem generates status assignments for the entities 160a-160n that results in the optimized total power consumption. The optimization module 110 is configured to use a search tool, such as, simulated annealing, hill climbing, local beam search, genetic algorithms, etc., to find a solution to the objective function. In other words, the optimization module 110 is configured to use the search tool to find status assignments and resource actuator settings that minimizes the total power consumed to perform the workloads. In addition, the optimization module 110 is configured to employ the entity power model(s) and the resource power model(s) while solving the optimization problem to determine impacts of the identified status assignments on the objective function.

Thus, by way of example, the optimization module 110 may identify candidate status assignments through implementation of the search tool and may determine entity 160a-160n power consumption levels through application of the entity power model(s) and the resource actuator 120a-120n power consumption levels through application of the resource power model(s). In addition, the optimization module 110 may identify the status assignments for the entities 160a-160n from the candidate status assignments that results in a substantially optimized total power consumption, such as, a substantially minimized total power consumption level, a total power consumption level that otherwise remains within a predefined threshold power consumption level, or a total power consumption level that is minimized with respect to the identified candidate status assignments.

At step 214, the optimization module 110 outputs data/instructions pertaining to the identified status assignments for the entities 160a-160n. The data pertaining to the identified status assignments may be outputted to the data store 116, displayed on a display device, printed by a printing device, communicated to a networked computing device or storage location, etc. The instructions pertaining to the status assignments may be communicated to the group controller 182. As discussed above, the group controller 182 is configured to dynamically assign the workloads as virtual machines to the specific entities 160a-160n according to the instructions received from the optimization module 110. In addition, the group controller 182 may cause specific ones of the entities 160a-160n to enter in a sleep, idle or off mode. Although the group controller 182 and the optimization module 110 have been depicted as forming separate components, the optimization module 110 may form part of the group controller 182 without departing from a scope of the optimizer 102.

As also discussed above, the resource controller 180 may operate to vary the operations of the resource actuators 120a-120n to compensate for the placements of the workloads on the entities 160a-160n and the status conditions of the entities 160a-160n. More particularly, for instance, the resource controller 180 may operate as disclosed in the TBD (Attorney Docket No. 200802683-1 application for patent to determine optimized settings of the resource actuators 120a-120n. The resource controller 180 may thus operate independently of the group controller 182. In addition, the resource controller 180 may be configured to determine and vary the operations of the resource actuators 120a-120n at shorter intervals of time than the intervals at which the group controller 182 varies the workload assignments on the entities 160a-160n.

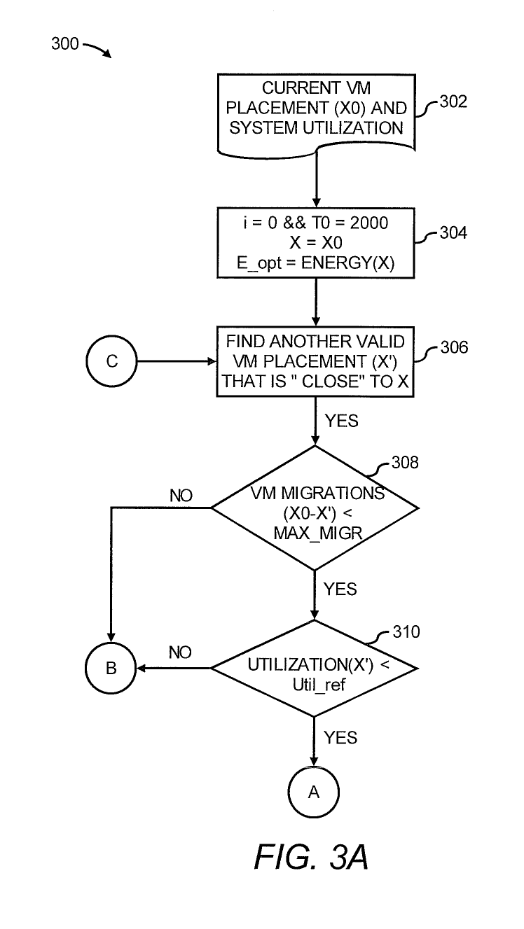

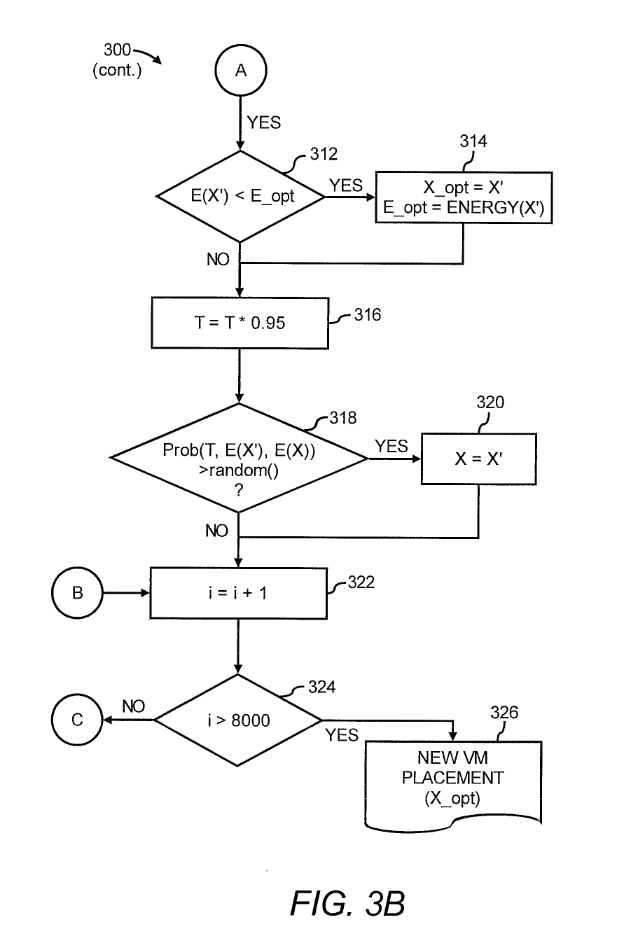

Turning now to FIGS. 3A and 3B, there is collectively shown a flow diagram of a method 300 of employing the search tool to solve a constraint optimization problem and to thus identify an assignment of workloads on the plurality of entities 160a-160n that results in the substantially optimized total power consumption, according to an example. It should be apparent to those of ordinary skill in the art that the method 300 represents a generalized illustration and that other steps may be added or existing steps may be removed, modified or rearranged without departing from a scope of the method 300.

The optimization module 110 may implement the method 300 to solve the constraint optimization problem. As such, the method 300 may be considered as providing a more detailed description of step 210 in FIG. 2. In addition, the method 300 is depicted as employing a simulated annealing tool to search for a solution to the optimization problem. It should, however, be understood that a simulated annealing tool has been used in one example and that other types of searching tools may also effectively be employed in various situations.

At step 302, a current placement (X0) of the virtual machines (VMs) is identified. In addition the current utilizations of the entities 160a-160n are identified based upon the placement of the VMs and by summing the VMs that are currently running on the entities 160a-160n. The current utilizations of the resource actuators 120a-120n may also be identified from input received from the resource actuators 120a-120n as discussed above. In addition, the current power consumption levels of the entities 160a-160n and the current power consumption levels of the resource actuators 120a-120n may be determined based upon the current utilization levels through use of the previously developed entity power model(s) and resource power model(s).

At step 304, a counter (i) is set to zero and an initial timing variable (T0), which identifies the length of time that the simulated annealing tool is to run is inputted into the simulated annealing tool. In addition, the VM placement (X) is set to the current VM placement (X0) and the current total power consumption, which is currently considered to be the optimal total power consumption (E_opt), is set to equal the energy consumption of the sum of the entity 160a-160n power consumption levels and the resource actuator 120a-120n power consumption levels.

At step 306, the current workload placement is perturbed to identify another VM placement (X′) that is relatively close to the current VM placement (X). More particularly, the simulated annealing tool looks at a random search that is relatively close to the current state of the system. Thus, for instance, the tool may perturb the system by moving a VM from a first entity 160a to a second entity 160b.

At step 308, the tool performs a check to determine whether the total number of VM migrations (X0-X′) falls within a maximum migration value (MAX_MIGR). The maximum migration value, which may be user-defined, is employed to maintain workload stability, but is considered optional in various instances. If the total number of VM migrations falls below the maximum migration value, the tool determines whether the new VM placement (X′) violates any utilization thresholds of the entities 160a-160n at step 310. In one regard, this check is performed to substantially ensure that the placement of the workloads does not negatively impact the performance of the entities 160a-160n.

If the tool determines that the new VM placement (X′) does not violate any of the utilization thresholds of the entities 160a-160n, the tool implements the entity power model and the resource power model to calculate the energy consumption (E(X′)) associated with the new VM placement (X′), as indicated at step 312. In other words, at step 312, the tool determines whether the energy consumption (E(X′)) is below the optimal energy consumption level (E_opt) previously denoted at step 302. If the tool determines that the energy consumption (E(X′)) is less than the previously denoted optimal energy consumption level (E_opt), the tool defines the optimal VM placement (X_opt) as the new VM placement (X′) and the optimal energy consumption level (E_opt) as the energy consumption level (E(X′)).

At step 316, the tool changes the value of a time varying parameter T, which is referred to as the temperature in simulated annealing algorithms. According to an example, the value of the temperature (T) is varied by a relatively small amount, for instance, 5%, which indicates that the simulated annealing temperature is decreasing exponentially.

At step 318, a probability is generated as a function of the temperature (T), the energy associated with the new placement (E(X′)), and the energy associated with the current valid VM placement (X′). If the energy (E(X′)) is less than the energy (E(X)), the probability is 1. In other words, if (E(X′)<E(X)), prob=1. Otherwise, it is a decreasing function of the energy difference between (E(X′)) and (E(X)), and also a decreasing function of the temperature (T). In other words, else prob=exp((E(X)−E(X′))/T. The probability is then compared with a randomly generated number. If the probability exceeds the random probability, at step 320, the new VM placement (X′) is accepted. In other words, the new VM placement (X′) will be accepted with the probability equal to one, if the energy (E(X′)) of the new placement is reduced compared with that of the current valid VM placement (X) to the new VM placement (X′). In one regard, this is to help the tool to substantially avoid becoming stuck at a local optimum. Following either of steps 318 and 320, the tool increments the counter (i) by one, as indicated at step 322. The tool also performs step 322 following the “no” conditions from steps 308 and 310 discussed above.

In addition, at step 324, the tool determines whether the counter (i) has reached a predefined maximum number of iterations, which may be user defined, as shown at step 324. By way of particular example only, the tool determines whether the counter exceeds 8000 iterations. If the tool determines that the counter has reached the predefined maximum number of iterations, the tool outputs the most recently identified optimal VM placement (X_opt) is identified as the VM placement that results in the optimized power consumption level.

If, however, the tool determines that the counter (i) has not reached the predefined maximum number of iterations at step 324, the tool finds another valid VM placement (X′) that is relatively close to the previously modified VM placement (X), as indicated at step 306. In addition, the tool repeats steps 308-324 until the counter (i) indicates that the predefined maximum number of iterations has been performed, at which time the tool outputs an indication that the VM placement identified at step 306 or at step 320 during a previous iteration resulted in the lowest total energy consumption level, while remaining within the constraints set forth at steps 308 and 310.

A particular example of an application of the methods 200 and 300 will now be provided. In this particular example, the optimizer 102 is embodied in the group controller 182, the entities 160a-160n comprise blade servers contained in an enclosure, and the resource actuators 120a-120n comprise fans for cooling the blade servers. The environmental condition to be maintained at the locations of the blade servers is temperature. In addition, Xen VMs are used for workload migration among the blade servers and a simulated annealing tool is used as the search algorithm.

The inputs to the group controller 182 are workload demand, blade utilization, current VM-to-blade assignment, blade CPU temperatures, and blade ambient temperatures. As each workload is hosted within a VM, the demand is available as the utilization of individual VMs. The main actuators available to the group controller 182 is VM migration, that is, the assignment and/or re-assignment of VMs to the blade servers 160a-160n as well as changing other status assignments of the blade servers 160a-160n, such as, on/off, idle/awake, etc. assignments. Thus, for instance, the group controller 182 is configured to power off all of the blade servers 160a-160n that do not have resident VMs and to power those blade servers back on as VMs are assigned to those blade servers 160a-160n. In addition, the group controller 182 may place certain ones of the blade servers 160a-160n to be in different sleep modes, which may include, for instance, placing some blade servers 160a-160n into an off state when those blade servers 160a-160n enter an idle state to conserve greater amounts of power.

As discussed above with respect to the optimizer module 110, the group controller 182 is configured to identify a VM placement among the blade servers 160a-160n, the power state, such as, an off condition, etc., that optimizes a total power consumed by the blade servers 160a-160n in performing demanded workloads and the fans 120a-120n in maintaining the blade servers 160a-160n at predefined temperatures. The task of the group controller 182 may be formulated as an optimization problem with the objective of minimizing blade and fan power consumption given by Equation (5) above and the temperature and utilization constraints respectively given by Equations (6) and (7) above. This problem is relatively difficult to solve because the utilization of a blade server is a discrete variable and cannot be continuously varied.

Since a VM must migrate atomically, the granularity of change in utilization depends upon the utilization levels of the VMs and the power settings of the blade servers 160a-160n. These differences make the optimization problem intractable using conventional optimization techniques. The group controller 182 is thus configured to use a search tool that is capable of optimizing over a large search space. By way of example, the group controller 182 may employ simulated annealing because it is particularly useful for discrete search spaces and is less likely to get stuck at a local minima as discussed above with respect to the method 300. As also discussed above with respect to the method 300, the simulated annealing tool requires generation and comparison of solution candidates to move closer to a more efficient solution. In order to compare two candidate VM placements, the group controller 182 computes both the blade server 160a-160n power and the fan 120a-120n power through use of entity and resource power models, that were previously developed, for instance, by the entity power model module 104 and the resource power model module 106. While the blade server power is relatively easily computed from the utilization values of the blade servers 160a-160n, the fan 120a-120n power is relatively more difficult because it requires determination of the optimal fan speed settings for that VM assignment. This becomes an optimization problem similar to that solved by the resource controller 180 as discussed in the TBD (Attorney Docket No. 200802683-1 application for patent.

As discussed in that application for patent, the power consumption level of a fan (fan power) is a cubic function of the rotational speed of the rotor given in revolutions per minute (RPM). This relationship may be determined by manually setting the fan speed (FS) and then recording the power consumption level of the individual fan. According to an example, the fan power (P) of an individual fan (i) is approximated using a 3^{rd} order polynomial, as shown in the following equation:

P_{F,i}=a₀*FSᵢ³+a₁*FSᵢ²+a₂*FSᵢ. Equation (8):

In Equation (8), the parameters a0, a1, and a2 may be determined by fitting the parameters into experimental data. However, instead of the transient model employed in that application for patent, the group controller 182 may employ a steady-state thermal model, which is relatively simpler to solve than the transient model employed in that application for patent. An example of the steady-state model that is configured to predict steady state CPU temperature T_{CPU}_{ⱼ} as a function of utilization (gUTILⱼ+P_{CPU}_{_{idle}}), fan speed (FSᵢ) of the fan i and ambient temperature T_{amb}_{ⱼ} is shown in the following equation:

$${T}_{{CPU}_{j}} = {Σ}_{i} {η}_{ij} k ( {gUTIL}_{j} + {P}_{{CPU}_{idle}} ) {FS}_{i} + {C}_{R} ( {gUTIL}_{j} + {P}_{{CPU}_{idle}} ) + {T}_{{amb}_{j}} . \qquad Equation ( 9 )$$

In Equation (9), ηᵢⱼ is the airflow correlation index that maps fan speed to the flow rate in blade j, k represents a weighting factor on the flow rate and is related to fluid and material properties and geometry, and C_{R} approximately represents the thermal resistance of a blade server at zero flow rate.

The constraints of the optimization problem (formulated at step 208) may comprise blade server temperature constraints, for instance, as represented in the following equation:

$${Σ}_{i} k {η}_{ij} {FS}_{i} \leq \frac{{C}_{2 , j} ( {T}_{{CPU}_{j}}^{P} - {T}_{{amb}_{j}}^{P} )}{{Q}_{j} - \frac{{C}_{1 , j}}{Δ t} ( {T}_{ref} - {T}_{{CPU}_{j}}^{P} )} - {C}_{R} . \qquad Equation ( 10 )$$

In addition, a further constraint of the optimization problem may specify the upper bound (UB) and lower bound (LB) on the speeds of the fans (i), for instance, as given by the following equation:

LBᵢ≦FSᵢ≦UBᵢ. Equation (11):

Together, Equations (9), (10), and (11) describe an optimization problem with a cubic objective function and linear constraints. This is a convex optimization problem and the group controller 182 may solve this problem using conventional mathematical tools, such as, interior points methods. In addition, the solution to this optimization problem provides the optimal settings for the fan speeds for a candidate VM placement.

In addition, in order to narrow the search space and increase the probability of generating a better solution candidate, the group controller 182 may employ a heuristic function that selects VM assignments with blade servers 160a-160n associated with lower ηᵢⱼ values because a low ηᵢⱼ value implies a strong influence of fan i at blade j. Similarly, lower values of ηᵢⱼ indicate that the blade i may be cooled in multiple ways and hence there is a greater probability of identifying a fan speed combination with lower power consumption.

According to another embodiment, although the main objective of the group controller 182 is to minimize total power consumption, if multiple feasible VM assignments exists with equal or substantially equal power cost, the group controller 182 may select the one with the minimum number of VM migrations to reduce overhead. This requirement is captured in the method 300 by the placement of an upper bound on the number of VM migrations allowed in a VM assignment (step 308).

Some or all of the operations set forth in the methods 200 and 300 may be contained as a utility, program, or subprogram, in any desired computer accessible medium. In addition, the methods 200 and 300 may be embodied by computer programs, which can exist in a variety of forms both active and inactive. For example, they may exist as software program(s) comprised of program instructions in source code, object code, executable code or other formats. Any of the above may be embodied on a computer readable medium, which include storage devices.

Exemplary computer readable storage devices include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

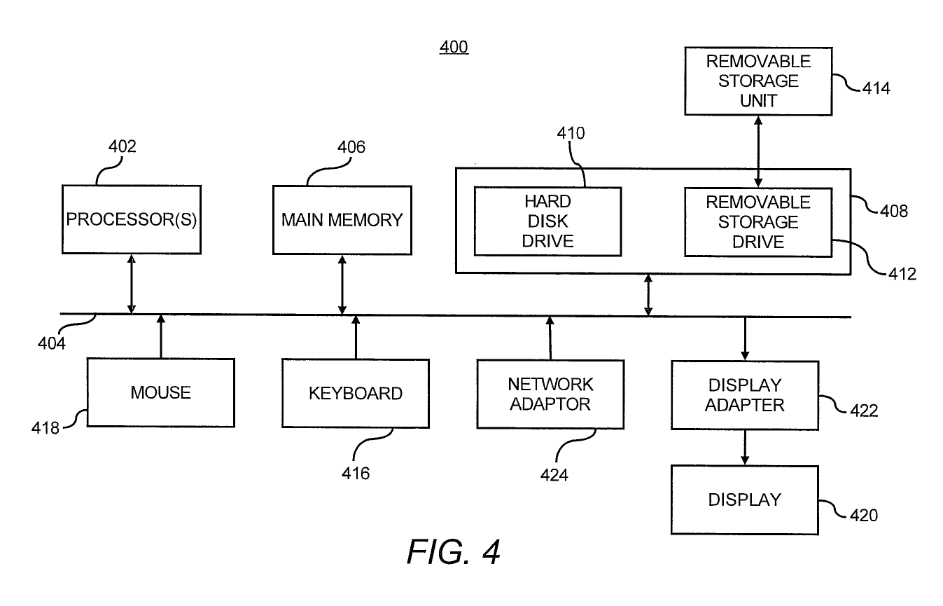

FIG. 4 illustrates a block diagram of a computing apparatus 400 configured to implement or execute the optimizer 102 depicted in FIGS. 1A and 1B, according to an example. In this respect, the computing apparatus 400 may be used as a platform for executing one or more of the functions described hereinabove with respect to the optimizer 102.

The computing apparatus 400 includes a processor 402 that may implement or execute some or all of the steps described in either or both of the methods 200 and 300. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for one or both of the methods 200 and 300 may be stored.

The removable storage drive 410 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands for the display 420. In addition, the processor(s) 402 may communicate over a network, for instance, the Internet, LAN, etc., through a network adaptor 424.

It will be apparent to one of ordinary skill in the art that other known electronic components may be added or substituted in the computing apparatus 400. It should also be apparent that one or more of the components depicted in FIG. 4 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

1. A computer readable storage medium on which is embedded one or more computer programs, said one or more computer programs implementing a method for determining status assignments for a plurality of entities that substantially optimizes a total power consumption of the plurality of entities and a plurality of resource actuators configured to variably supply resources to the plurality of entities, said one or more computer programs comprising a set of instructions for:
developing at least one entity power model for the plurality of entities;
developing at least one resource power model for the plurality of resource actuators;
formulating a constraint optimization problem having an objective function and at least one constraint; and
solving the constraint optimization problem by employing a search tool, the at least one entity power model, and the at least one resource power module on the objective function to identify status assignments for the plurality of entities that results in the optimized total power consumption.

2. The computer readable storage medium according to claim 1, said one or more computer programs comprising a further set of instructions for:
receiving substantially real time conditions; and
wherein solving the constraint optimization problem further comprises solving the constraint optimization problem based upon the received substantially real time conditions.

3. The computer readable storage medium according to claim 1, wherein solving the constraint optimization problem further comprises employing the at least one entity power model and the at least one resource power model to determine impacts of the identified status assignments on the objective function, said one or more computer programs comprising a further set of instructions for:
employing the determined impacts of the identified status assignments to identify the status assignment that results in the substantially optimized total power consumption,

4. The computer readable storage medium according to claim 1, wherein solving the optimization problem further comprises identifying a plurality of candidate status assignments and determining total power consumption levels of each of the plurality of candidate status assignments through application of the at least one entity power model and the at least one resource power model and selecting the candidate status assignment associated with a minimum total power consumption level as the identified status assignment that results in the substantially optimized total power consumption.

5. The computer readable storage medium according to claim 1, said one or more computer programs comprising a further set of instructions for:
developing at least one condition model that relates the settings of the plurality of resource actuators to an environmental condition at the locations of the plurality of entities and power consumption levels of the plurality of entities; and
wherein formulating the constraint optimization problem further comprises employing the at least one condition model to formulate the at least one constraint.

6. The computer readable storage medium according to claim 1, wherein the at least one entity power model characterizes the relationship between a utilization level and a power consumption level of the plurality of entities, wherein the at least one resource power model relates settings of the plurality of resource actuators to power consumption levels of the plurality of resource actuators, wherein the objective function is configured to minimize entity and resource infrastructure power consumption, and wherein the at least one constraint comprises at least one of setpoint environmental conditions at locations of the plurality of entities and maximum entity resource utilization levels.

7. The computer readable storage medium according to claim 1, wherein solving the constraint optimization problem further comprises employing at least one of a simulated annealing, hill climbing, local beam search, and genetic algorithm as the search tool.

8. The computer readable storage medium according to claim 1, said one or more computer programs comprising a further set of instructions for:
setting the plurality of entities to have power consumption settings according to the identified status assignments;
determining optimal settings for the plurality of resource actuators based upon the status assignments on the plurality of entities; and
setting the plurality of resource actuators to the determined optimal settings,

9. A computer-implemented optimizer for determining status assignments for a plurality of entities that substantially optimizes at total power consumption of the plurality of entities and a plurality of resource actuators configured to variably supply resources to the plurality of entities, said computer-implemented. optimizer comprising:
an input module for receiving data from a plurality of input sources;
an entity power model module configured to develop at least one entity power model for the plurality of entities from the received data;
a resource power model module configured to develop at least one resource power model for the plurality of resource actuators from the received data; and
an optimization module configured to formulate a constraint optimization problem having an objective function and at least one constraint, wherein the optimization module is further configured to solve the constraint optimization problem by employing a search tool, the at least one entity power model, and the at least one resource power module on the objective function to identify status assignments for the plurality of entities that results in the optimized total power consumption.

10. The computer-implemented optimizer according to claim 9, further comprising: an output module configured to output the identified status assignments.

11. The computer-implemented optimizer according to claim 9, wherein the optimization module is further configured to solve the constraint optimization problem by employing the at least one entity power model and the at least one resource power model to determine impacts of the identified status assignments on the objective function and employing the determined impacts of the identified status assignments to identify the status assignments that result in the substantially optimized total power consumption.

12. The computer-implemented optimizer according to claim 9, wherein the optimization module is further configured to identify a plurality of candidate status assignments, to determine total power consumption levels of each of the plurality of candidate status assignments through application of the at least one entity power model and the at least one resource power model, and to select the candidate status assignment associated with a minimum total power consumption level as the identified status assignment that results in the substantially optimized total power consumption.

13. The computer-implemented optimizer according to claim 9, further comprising:
a group controller configured to set the plurality of entities to have power consumption settings according to the identified status assignments; and
a resource controller configured to determine optimal settings for the plurality of resource actuators based upon the status assignments on the plurality of entities and to set the plurality of resource actuators to the determined optimal settings.

14. The computer-implemented optimizer according to claim 9, wherein the at least one entity power model characterizes the relationship between a utilization level and a power consumption level of the plurality of entities, wherein the at least one resource power model relates settings of the plurality of resource actuators to power consumption levels of the plurality of resource actuators, wherein the objective function is configured to minimize entity and resource infrastructure power consumption, and wherein the at least one constraint comprises at least one of setpoint environmental conditions at locations of the plurality of entities and maximum entity resource utilization levels.

15. A computing apparatus comprising:
a memory storing code for:
developing at least one entity power model for the plurality of entities;
developing at least one resource power model for the plurality of resource actuators;
formulating a constraint optimization problem having an objective function and at least one constraint; and
solving the constraint optimization problem by employing a search tool, the at least one entity power model, and the at least one resource power module on the objective function to identify status assignments for the plurality of entities that results in the optimized total power consumption; and
a processor for executing the code stored in the memory to determine status assignments for a plurality of entities that substantially optimizes a total power consumption of the plurality of entities and a plurality of resource actuators configured to variably supply resources to the plurality of entities.

16. The computer readable storage medium according to claim 2, wherein solving the constraint optimization problem further comprises employing the at least one entity power model and the at least one resource power model to determine impacts of the identified status assignments on the objective function, said one or more computer programs comprising a further set of instructions for:
employing the determined impacts of the identified status assignments to identify the status assignment that results in the substantially optimized total power consumption.

17. The computer readable storage medium according to claim 2, wherein solving the optimization problem further comprises identifying a plurality of candidate status assignments and determining total power consumption levels of each of the plurality of candidate status assignments through application of the at least one entity power model and the at least one resource power model and selecting the candidate status assignment associated with a minimum total power consumption level as the identified status assignment that results in the substantially optimized total power consumption.

18. The computer-implemented optimizer according to claim 10, wherein the optimization module is further configured to solve the constraint optimization problem by employing the at least one entity power model and the at least one resource power model to determine impacts of the identified status assignments on the objective function and employing the determined impacts of the identified status assignments to identify the status assignments that result in the substantially optimized total power consumption.

19. The computer-implemented optimizer according to claim 10, wherein the optimization module is further configured to identify a plurality of candidate status assignments, to determine total power consumption levels of each of the plurality of candidate status assignments through application of the at least one entity power model and the at least one resource power model, and to select the candidate status assignment associated with a minimum total power consumption level as the identified status assignment that results in the substantially optimized total power consumption.

20. The computer-implemented optimizer according to claim 10, further comprising:
a group controller configured to set the plurality of entities to have power consumption settings according to the identified status assignments; and
a resource controller configured to determine optimal settings for the plurality of resource actuators based upon the status assignments on the plurality of entities and to set the plurality of resource actuators to the determined optimal settings.
